(19) United States
(12) Patent Application Publication
(10) Pub. No.: US 2014/0282683 A1
(43) Pub. Date: Sep. 18, 2014

(54) COMPUTING SYSTEM WITH DEVICE INTERACTION MECHANISM AND METHOD OF OPERATION THEREOF

(71) Applicant: SAMSUNG ELECTRONICS CO., LTD., Gyeonggi-Do (KR)

(72) Inventors: Wei-Meng Chee, Sunnyvale, CA (US); Brenno Cantelli, Cupertino, CA (US)

(21) Appl. No.: 13/863,592

(22) Filed: Apr. 16, 2013

Related U.S. Application Data
(60) Provisional application No. 61/783,658, filed on Mar. 14, 2013.

(51) Int. Cl. H04N 21/6334; H04N 21/258

(52) U.S. Cl. CPC H04N 21/6334; H04N 21/25816
USPC 725/30; 725/110

(57) ABSTRACT

A computing system includes a trait-recognition module configured to detect a physical identification signature for representing a user; a device-recognition module, coupled to the trait-recognition module, configured to detect a device-identification for representing a device closely associated with the user; and a connection module, coupled to the device-recognition module, configured to establish a device-grouping based on the physical identification signature for connecting the device with a further device for displaying a content on the device, the further device, or a combination thereof.

### CROSS-REFERENCE TO RELATED APPLICATION(S)

This application claims the benefit of U.S. Provisional Patent Application Ser. No. 61/783,658 filed Mar. 14, 2013, and the subject matter thereof is incorporated herein by reference thereto.

### TECHNICAL FIELD

An embodiment of the present invention relates generally to a computing system, and more particularly to a system for managing functions across multiple devices.

### BACKGROUND

Modern consumer and industrial electronics, especially devices such as computer systems, televisions, projectors, cellular phones, portable digital assistants, and combination devices, are providing increasing levels of functionality to support modern life including supporting user tasks. Research and development in the existing technologies can take a myriad of different directions.

The increasing demand for information in modern life requires users to access information at any time, while variety of consumer devices allow for increased functionalities. However, the interactions between the consumer devices have been limited and difficult for the user to fully utilize.

Thus, a need still remains for a computing system with device interaction mechanism for improving transfer of information. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a computing system, including: a trait-recognition module configured to detect a physical identification signature for representing a user; a device-recognition module, coupled to the trait-recognition module, configured to detect a device-identification for representing a device closely associated with the user; and a connection module, coupled to the device-recognition module, configured to establish a device-grouping based on the physical identification signature and the device-identification for connecting the device with a further device for displaying a content on the device, the further device, or a combination thereof.

An embodiment of the present invention provides a method of operation of a computing system including: detecting a physical identification signature for representing a user; detecting a device-identification for representing a device closely associated with the user; and establishing a device-grouping based on the physical identification signature and the device-identification for connecting the device with a further device for displaying a content on the device, the further device, or a combination thereof.

An embodiment of the present invention provides non-transitory computer readable medium including: detecting a physical identification signature for representing a user; detecting a device-identification for representing a device closely associated with the user; and establishing a device-grouping based on the physical identification signature and the device-identification for connecting the device with a further device for displaying a content on the device, the further device, or a combination thereof.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with device interaction mechanism in an embodiment of the present invention.

FIG. 2 is an example of a display interface of the group-accommodation device.

FIG. 3 is a further example of the display interface.

FIG. 4 is a further example of the display interface.

FIG. 5 is an exemplary block diagram of the computing system.

FIG. 6 is a further exemplary block diagram of the computing system

FIG. 7 is a further exemplary block diagram of the computing system

FIG. 8 is a control flow of the computing system.

FIG. 9 is a flow chart of a method of operation of a computing system in an embodiment of the present invention.

### DETAILED DESCRIPTION

The following embodiment can be used to establish a connection between devices using a device-grouping based on identifying a user through a physical identification signature and a device-identification for representing user's unique physical traits and user's personal device. Content and personalized material related to the content can be provided to the user across various devices connected through the device-grouping.

The combination of the physical identification signature and the device association provide improved accuracy in identifying individual users, while the device-grouping allows personalization by providing the personalized material on a device associated with specific user. The device-grouping based on the physical identification signature and the device association and without the direct-input from a user provide improved usability and user-specific features without requiring user inputs.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. Where the embodiments have been numbered first embodiment, second embodiment, etc., the ordinal numbering is a matter of descriptive convenience and is not intended to have any other significance or provide limitations for an embodiment of the present invention.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

Referring now to FIG. 1, therein is shown a computing system 100 with device interaction mechanism in an embodiment of the present invention. The computing system 100 includes a personal device 102, such as a client or a server, connected to a group-accommodation device 106, such as a client or server. The computing system 100 can further include a peripheral device 108, such as a client or server. The peripheral device 108 can be connected to the group-accommodation device 106, the personal device 102, or a combination thereof.

The computing system 100 can further include a host device 110, such as a client or a server, connected to the personal device 102, the group-accommodation device 106, the peripheral device 108 or a combination thereof. The personal device 102, the group-accommodation device 106, the host device 110, the peripheral device 108, or a combination thereof can communicate using a communication path 104, such as a wireless or wired network.

For example, the personal device 102, the group-accommodation device 106, the host device 110, the peripheral device 108, or a combination thereof can be of any of a variety of devices. The personal device 102, the group-accommodation device 106, the host device 110, the peripheral device 108, or a combination thereof can be a computing device, such as a desktop computer, server, a router, or a laptop computer.

Continuing with the example, the personal device 102, the group-accommodation device 106, the host device 110, the peripheral device 108, or a combination thereof can also be multi-functional mobile communication, such as a cellular phone, personal digital assistant, a notebook computer, a tablet computer, a desktop computer, or a smart phone. The personal device 102, the group-accommodation device 106, the host device 110, the peripheral device 108, or a combination thereof can further be an entertainment or audio visual device, such as a television, a projector, a display monitor, a broadcasting station transmitter, a game console, a media player, a desktop computer, a tablet computer, or a smart phone.

Continuing with the example, the personal device 102, the group-accommodation device 106, the host device 110, the peripheral device 108, or a combination thereof can couple, either directly or indirectly, to the communication path 104 to communicate with each other. The personal device 102, the group-accommodation device 106, the host device 110, the peripheral device 108, or a combination thereof can also be stand-alone devices.

As a more specific example, the personal device 102 can be a personalized device linked with a user (not shown). The personal device 102 can be a device having dedicated features or identifications associated with the user, such as a telephone number, an access or encryption key, or a combination thereof, a device owned by the user, or a combination thereof. The personal device 102 can be a device that the user has on his or her person. The personal device 102 can include a viewing device, a watch or other wearable electronic device, a smart phone, a tablet computer, a laptop computer, an electronic key device, an identification mechanism, or a combination thereof.

For illustrative purposes, the computing system 100 is described with the personal device 102 as a portable personal computing device as described above, although it is understood that the personal device 102 can be different types of devices. For example, the personal device 102 can also be a non-personal or shared device or a stationary device, such as a server or a television.

Also as a more specific example, the group-accommodation device 106 can be a non-personal or shared device. The group-accommodation device 106 can be a device for providing dedicated features or functionalities simultaneously for one or multiple users. The group-accommodation device 106 can include a router, a television, a projector, a desktop computer, a smart home system or an interface therein, or a combination thereof.

Continuing with the example, the group-accommodation device 106 can be a mobile device or a non-mobile device and include components for providing the dedicated features, such as dedicated hardware accelerator, specialized software or firmware, or a combination thereof. The dedicated features can include a display screen having a size larger than portable personal devices or a picture quality, such as brightness or definition, superior to the personal device 102. The dedicated features can also include a communication management subsystem for accommodating multiple users simultaneously, or a combination thereof.

For illustrative purposes, the computing system 100 is described with the group-accommodation device 106 as a non-mobile computing or entertainment device as described above. However, it is understood that the group-accommodation device 106 can be different types of devices. For example, the group-accommodation device 106 can also be a server or a portable computing device, such as a laptop computer, a smart phone, or a tablet computer.

The peripheral device 108 can be a further instance of the portable personal computing device. The peripheral device 108 can be a further instance of the non-personal or shared device. The peripheral device 108 can be a mobile device or a non-mobile device. The peripheral device 108 can be similar to the personal device 102, the group-accommodation device 106, or a combination thereof. The peripheral device 108 can include a laptop computer, a desktop computer, or a tablet computer shared by a family, or a workstation accessible by multiple employees.

Also as a more specific example, the host device 110 can be any of a variety of centralized or decentralized computing devices, or video transmission devices. For example, the host device 110 can be a broadcasting station, a web server or a content provider, a multimedia computer, a laptop computer, a desktop computer, a video game console, grid-computing resources, a virtualized computer resource, cloud computing resource, routers, switches, peer-to-peer distributed computing devices, or a combination thereof.

The host device 110 can be centralized in a single room, distributed across different rooms, distributed across different geographical locations, embedded within a telecommunications network. The host device 110 can couple with the communication path 104 to communicate with the personal device 102, the group-accommodation device 106, the peripheral device 108, or a combination thereof. The host device 110 can also be a client type device as described for the personal device 102.

For illustrative purposes, the computing system 100 is described with the host device 110 as a computing device, although it is understood that the host device 110 can be different types of devices. Also for illustrative purposes, the computing system 100 is shown with the personal device 102, the group-accommodation device 106, the peripheral device 108, and the host device 110 as end points of the communication path 104, although it is understood that the computing system 100 can have a different partition between the personal device 102, the group-accommodation device 106, the peripheral device 108, the host device 110, and the communication path 104. For example, the personal device 102, the group-accommodation device 106, the host device 110, or a combination thereof can also function as part of the communication path 104.

The communication path 104 can span and represent a variety of networks. For example, the communication path 104 can include wireless communication, wired communication, optical, ultrasonic, or the combination thereof. Satellite communication, cellular communication, Bluetooth, near field communication (NFC), Infrared Data Association standard (IrDA), wireless fidelity (WiFi), and worldwide interoperability for microwave access (WiMAX) are examples of wireless communication that can be included in the communication path 104.

Also for example, Ethernet, digital subscriber line (DSL), fiber to the home (FTTH), and plain old telephone service (POTS) are examples of wired communication that can be included in the communication path 104. Further, the communication path 104 can traverse a number of network topologies and distances.

For example, the communication path 104 can include direct connection, personal area network (PAN), local area network (LAN), metropolitan area network (MAN), wide area network (WAN), or a combination thereof. Also for example, the communication path 104 can include a software defined radio (SDR).

Referring now to FIG. 2, therein is shown an example of a display interface 202 of the group-accommodation device 106. The display interface 202 can show an access profile 204. The access profile 204 is information regarding instances of an individual user 205 for accessing the computing system 100. The access profile 204 can be used for allowing control or use of one or more devices in the computing system 100 to the instances of the individual user 205. The computing system 100 can use the access profile 204 to manage an interaction between various devices with minimal user interaction.

The access profile 204 can include one or more groupings of information corresponding to individual members. For example, the access profile 204 can include an individual-member profile 206 and a further-member profile 208. The individual-member profile 206 is a set of information corresponding to the individual user 205 for accessing the computing system 100. The individual-member profile 206 can be used for identifying and allowing control or use of one or more devices specific to the individual user 205.

The individual-member profile 206 can include a variety of information associated with the individual user 205. For example, the individual-member profile 206 can include a physical identification signature 210, a device association 212, an access level 214, an access history 216, a recommendation preference 218, a device-use preference 220, or a combination thereof.

The physical identification signature 210 is data representing physical traits unique to the individual user 205. The physical identification signature 210 can be used for recognizing the individual user 205 for the computing system 100. For example, the physical identification signature 210 can include outer appearance, sequence of sounds, specific movement patterns, or a combination thereof unique to the individual user 205.

The physical identification signature 210 can include an appearance signature 222, an auditory signature 224, a motion signature 226, or a combination thereof for recognizing the individual user 205. The appearance signature 222 is representation of one or more visible physical traits in an appearance of the individual user 205. The appearance signature 222 can be traits unique to the individual user 205. For example, the appearance signature 222 can be facial features, height, posture, details in the individual user's eye, or a combination thereof.

The auditory signature 224 is representation of one or more auditory characteristics unique to the individual user 205. For example, the auditory signature 224 can be voice characteristics including diction, accent, tone, modulation, timbre, or a combination thereof.

The motion signature 226 is a representation of a sequence of movements for one or more physical traits. For example, the motion signature 226 can be a pattern of movements for one or more body parts of the individual user 205 characteristic of walking motions. Also for example, the motion signature 226 can be specific set of movements designated by the individual user 205 for identification purposes. For a more specific example, the motion signature 226 can be a position, a shape, an orientation, or a combination thereof for a finger, a hand, an arm, torso, or a combination thereof of the individual user 205.

The device association 212 is data for recognizing a relationship between the individual user 205 corresponding to the physical identification signature 210 and one or more devices. The device association 212 can include a device-identification 228 and a corresponding instance of an ownership-rating 230.

The device-identification 228 can be data representing a unique instance of a device. For example, the device-identification 228 can identify the personal device 102 of FIG. 1, the group-accommodation device 106, the peripheral device 108 of FIG. 1, the host device 110 of FIG. 1, or a combination thereof. Also for example, the device-identification 228 can include a serial number, a batch number, manufacturer information, a model distinction, a categorical distinction, a user assigned name, a capability list, a supported media-type list, or a combination thereof.

The ownership-rating 230 is a description of an association or a relationship between the device in the device-identification 228 and the individual user 205 corresponding to the physical identification signature 210. The ownership-rating 230 can include a score, a classification, a ranking, or a combination thereof based on an assessment regarding possession, frequency of use, degree of control, typical use, common context surrounding the use, or a combination thereof between the device in the device-identification 228 and the individual user 205 corresponding to the physical identification signature 210.

For example, the ownership-rating 230 can have a value of “high”, “personal”, “private”, or a combination thereof for a smartphone or electronic viewing glasses since the ownership, control, and typical use for such devices are personal in nature and often closely associated with the identity and the person of the individual user 205. Also for example, the ownership-rating 230 for a television can be a value representing a more public or shared relationship between the individual user 205 and the television since multiple people can watch or control the television and is often not closely associated with the identity or the person of the individual user 205.

A device can be closely associated with the person of the individual user 205 when the device is worn, carried, used, or a combination thereof for most of the day or more than a predetermined number of hours within a day. A device can be closely associated with the identity of the individual user 205 when information associated with the device, such as a phone number or login name, is directly related to the individual user 205 and can be used to identify the individual user 205 or reach the individual user 205 during most of the day or for more than a predetermined number of hours within a day.

The computing system 100 can use the physical identification signature 210, the device association 212, or a combination thereof to identify the individual user 205 and connect devices associated with the individual user 205. Details regarding the determination and use of the physical identification signature 210 and the device association 212 will be discussed below.

The access level 214 is a representation of features or functions of the computing system 100 accessible to or available for control by the individual user 205. For example, the access level 214 can be a complete-access 232, a partial-access 234, a non-control access 236, a content-based access 238, or a combination thereof.

The complete-access 232 can represent system administrator privileges or complete access of all available functions. The complete-access 232 can include function or accessibility for setting or adjusting the access level 214 for various other users of the computing system 100. The complete-access 232 can further include function or accessibility for transferring or managing content between devices of the computing system 100, creating or deleting the individual-member profile 206 for the other users, overriding commands or access inputs to the computing system 100 other users of the computing system 100 or a combination thereof.

The partial-access 234 can represent limited set of privileges or access of available functions. The partial-access 234 can specifically exclude the ability for the individual user 205 to set or modify the access level 214 of any user, create or delete any instance of the individual-member profile 206, or a combination thereof. For example, the partial-access 234 can include changing a channel or a volume level on a television, sending or receiving content between devices, functions or accesses specified by the individual user 205 having the complete-access 232 or the computing system 100, or a combination thereof.

The non-control access 236 can represent a smaller set of privileges or access of available functions excluding ability to control the computing system 100 or shared devices therein. For example, the non-control access 236 can allow a limited user to only receive content from other devices without the ability to send to the other devices. Also for example, the non-control access 236 can limit or exclude the ability of the limited user to control the group-accommodation device 106, the host device 110, or a combination thereof.

The content-based access 238 can represent a set of privileges or access to the computing system 100 based on content that is being accessed or provided through the computing system 100. For example, the content-based access 238 can exclude privileges or accesses related to content identified by the individual user 205 having complete-access 232 or the computing system 100, such as based on age or rating, categories, or a combination thereof. Also for example, the content-based access 238 can further be limited by access duration, access time, or a combination thereof.

The access history 216 is a record of connections between devices. The access history 216 can further include time, date, and duration of the previous connections.

The recommendation preference 218 is a representation of content material that the individual user 205 will likely enjoy. For example, the recommendation preference 218 can include categories or instances of music, movie, show, television channel, websites, articles, or a combination thereof similar to ones frequently accessed by the individual user 205, identified by the individual user 205 or the computing system 100, or a combination thereof.

The device-use preference 220 is as representation of details regarding use of one or more devices within the computing system 100. The device-use preference 220 can include a device setting 240, a delegation preference 242, or a combination thereof.

The device setting 240 is configuration, level, or control values associated with a corresponding device. For example, the device setting 240 can include sound or picture settings, icon arrangements, input settings, or a combination thereof.

The delegation preference 242 is a representation of interaction between multiple devices corresponding to an activity or task undertaken by the individual user 205 with the computing system 100. The delegation preference 242 can include various subtasks or features assigned to specific devices.

For example, the delegation preference 242 for watching a movie can include directing searches or shopping related or associated to the movie to a tablet, routing all calls designated for a smart phone to a house phone, presenting alternate soundtrack or subtitles on the smart phone, or a combination thereof. Also for example, the delegation preference 242 for a classroom or a work presentation setting can include enabling remote control features in the personal device 102 for controlling the group-accommodation device 106, computing using the host device 110, linking content or screens between the personal device 102 and the group-accommodation device 106, presenting alternate information, such as tutoring or research information on the peripheral device 108, or a combination thereof.

The further-member profile 208 is a set of information corresponding to a specific user different from the individual user 205 for accessing the computing system 100. The further-member profile 208 can be similar to the individual-member profile 206 but for a different user. For example, the further-member profile 208 can include instances of the physical identification signature 210, the device association 212, the access level 214, the access history 216, the recommendation preference 218, the device-use preference 220, or a combination thereof unique to a further user different from the individual user 205.

Referring now to FIG. 3, therein is shown a further example of the display interface 202. The display interface 202 can show a content 302, a device-grouping 304, a connection verification 306, a context 308, or a combination thereof.

The content 302 can be material intended for communication using the devices in the computing system 100. For example, the content 302 can be television or radio show, images and sounds of from a game, music, pictures, web pages, streaming media, or a combination thereof. Also for example, the content 302 can be communicated, such as by displaying or reproducing with available medium, to one or more users through the personal device 102 of FIG. 1, the group-accommodation device 106, the peripheral device 108 of FIG. 1, the host device 110 of FIG. 1, or a combination thereof.

The content 302 can further be communicated, such as by wired or wireless transmission, between devices. For example, the host device 110 can communicate the web page or the television program to the personal device 102, which can then communicate the content 302 to the group-accommodation device 106, the peripheral device 108, or a combination thereof for further communication with the individual user 205 of FIG. 2, such as by displaying images or reproducing sounds.

The device-grouping 304 is a connection between a set of devices for enabling sending and receiving information between devices. The device-grouping 304 can be a smaller or a local grouping of devices within the network 104 of FIG. 1. For example, the device-grouping 304 can include a connection between the personal device 102, the group-accommodation device 106, the peripheral device 108, the host device 110, other instances of the personal device 102 or the peripheral device 108 belonging to additional users, or a combination thereof.

The connection verification 306 is a representation of establishing a connection between a set of devices. The connection verification 306 can be a representation of an instance of a device joining the device-grouping 304. For example, the connection verification 306 can be a key, a network identifier, a confirmation message or status, a session identifier, or a combination thereof for the personal device 102, the group-accommodation device 106, the peripheral device 108, other instances of the personal device 102 or the peripheral device 108 belonging to additional users, or a combination thereof being included in the device-grouping 304.

The context 308 is a set of circumstances or conditions surrounding the content 302, the device-grouping 304, or a combination thereof. The context 308 can describe an event, a situation, an occasion, or a combination thereof associated with the content 302, the device-grouping 304, or a combination thereof. For example, the context 308 can be a social gathering based on watching a major sporting event. Also for example, the context 308 can be a classroom setting or a work-related meeting involving the device-grouping 304 of corresponding attendees.

The context 308 can be based on a contextual factor 310 associated with the context 308. The contextual factor 310 is a determinable aspect of a current circumstance or situation. The contextual factor 310 can include current time, current location of a device, metadata of the content 302, such as a title or a categorization, the instances of the individual-member profile 206 of FIG. 2 available for the device-grouping 304, a determination of relationships between users associated with the available instances of the individual-member profile 206 or sharing the same location, or a combination thereof.

The computing system 100 can determine the context 308 using the contextual factor 310. The computing system 100 can establish or adjust the device-grouping 304 based on the context 308. The computing system 100 can further adjust the individual-member profile 206, including the access level 214 of FIG. 2, based on the context 308. Details regarding the determination and use of the context 308 will be discussed below.

The display interface 202 can further show a content history 312, a personalized material 314, a security-tracking data 316, an initialization-recognition factor 318, or a combination thereof. The content history 312 is a record of content, function, or a combination thereof previously accessed by the individual user 205 corresponding to a device used for access, the individual-member profile 206, or a combination thereof. The content history 312 can further include time, date, and duration of the previous access.

The content history 312 can also include details regarding the content, the function, or a combination thereof access by the individual user 205 and the device used to access the content, the function, or a combination thereof. The content history 312 can include content, an activity, a task, or a combination thereof that have been paused or left unfinished by the individual user 205.

The personalized material 314 is material intended for communication to the individual user 205 through the devices in the computing system 100. The personalized material 314 can be associated with the content 302.

For example, the personalized material 314 can be alternative information or portions of the content 302, such as dubbed dialog or director commentary, associated facts, details regarding the content 302 or a portion therein, or a combination thereof related to the content 302. For a more specific example, the personalized material 314 can include speaker's biography, detailed data or explanations corresponding to a presented material, related search results corresponding to a presented material, personalized task list, or a combination thereof intended for a specific participant in a work-related meeting.

The computing system 100 can determine the personalized material 314 based on the context 308 and the content 302. The computing system 100 can communicate the personalized material 314 to the individual user 205 through an appropriate device using the individual-member profile 206. Details regarding the determination and use of the personalized material 314 will be discussed below.

The security-tracking data 316 is detailed information regarding an entity detected by the computing system 100. The security-tracking data 316 can be determined, stored, communicated, verified, or a combination thereof when the entity detected by the computing system 100 is unknown to the computing system 100. The security-tracking data 316 can include information similar to the physical identification signature 210 of FIG. 2, the device association 212 of FIG. 2, or a combination thereof.

For example, the security-tracking data 316 can include recordings involving images, sounds, or both, detected instances of physical traits, sequence of sounds, specific movements, or a combination thereof for the unidentified entity. Also for example, the security-tracking data 316 can include device identifications, such as serial numbers or tracking information, for all detected devices or for devices where detectability changes, such as by moving into or out of detection range or zone, based on detection of the unidentified entity.

The initialization-recognition factor 318 is a set of information for identifying an association between the individual user 205 and a particular device. The initialization-recognition factor 318 can be the contextual factor 310 or other information previously specified by the computing system 100 for recognizing the device association 212.

For example, the initialization-recognition factor 318 can include categorization of devices, length and duration of usage, proximity to the individual user 205, the context 308, or a combination thereof for recognizing the ownership-rating 230 of FIG. 2. Also for example, the initialization-recognition factor 318 can include initialization screen or message, registration information or confirmation, movement patterns for removing a device, identification of a device for the first time, amount of data stored in the device or a configuration of the device, or a combination thereof typical of initial usage of the device.

For illustrative purposes, the above described elements, such as the content 302 and the initialization-recognition factor 318 is described as being displayed on the group-accommodation device 106. However, it is understood that the above described elements can be displayed on any device within the computing system 100, including the personal device 102, the peripheral device 108, the host device 110, or a combination thereof.

Referring now to FIG. 4, therein is shown a further example of the display interface 202. The display interface 202 can display a recognition marker 402, a movement pattern 404, and a movement-command 406. The recognition marker 402 can be physical features of the individual user 205 of FIG. 2 or any other user as predefined by the computing system 100. For example, the recognition marker 402 can be a pattern of pixels corresponding to a finger, a hand, an arm, an eye, a nose, lips, a face, a shoulder, hips, any physical feature of a person, any portion or orientation thereof, or a combination thereof.

The movement pattern 404 can be a set of locations for the recognition marker 402 over a period of time. The movement pattern 404 can represent a motion or movement of the person for specifying a direct-input 408.

The direct-input 408 is a specific command or information input to the computing system 100 from the individual user 205. The direct-input 408 can include interactions for purpose of controlling one or more device in the computing system 100 to perform a specific function. For example, the direct-input 408 can include information, action, command, or a combination thereof given to the computing system 100 through user interfaces, such as a camera, a key board, a mouse, a touch screen, a microphone, a control mechanism, or a combination thereof.

The direct-input 408 can include the movement-command 406. The movement-command 406 is a representation of a physical movement of the individual user 205 corresponding to a specific action or functionality of one or more devices within the computing system 100. The movement-command 406 can include a threshold, a range, duration, or a combination thereof relating to the physical movement of the person.

The movement-command 406 can further correspond to the person's physical movement and interaction with the computing system 100. The movement-command 606 can be used to enable the person to provide input and issue commands for using functions of the computing system 100, such as establishing connection or transferring information between devices or controlling functions within a device, using physical movements, without contacting a mouse, a keyboard, a touch screen, or a combination thereof, and without typing.

The movement-command 406 can include various different movements corresponding to commands. For example, the movement-command 406 can include a device-point scenario 410, a device-tap scenario 412, a hand-raise scenario 414, a content-slide scenario 416, a point command scenario 418, a voice command scenario, or a combination thereof.

The device-point scenario 410 is a representation of a hand, the personal device 102 of FIG. 1, or a combination thereof relative to head, torso, the group-accommodation device 106 of FIG. 1, the peripheral device 108 of FIG. 1, or a combination thereof. The device-point scenario 410 can include relatively static or dynamic motions of the user.

The device-point scenario 410 can include a relatively static pointing motion using the personal device 102 or the peripheral device 108. The device-point scenario 410 can include the movement pattern 404 of one or more instances of the recognition maker 402 corresponding to a person's hand, finger, or a combination thereof holding the personal device 102 and orienting the personal device 102 or the peripheral device 108 in a direction toward another device, such as the personal device 102, the group-accommodation device 106, or the peripheral device 108.

The device-point scenario 410 can further include a dynamic pointing motion using the personal device 102 or the peripheral device 108. The device-point scenario 410 can include a set of arching or linear movements of a hand, finger, or a combination thereof relative to a torso. The device-point scenario 410 can include the movement pattern 404 of one or more instances of the recognition marker 402 corresponding to a person's hand, finger, or a combination thereof moving in a linear path, a curved path, or a combination thereof relative to other instances of the recognition marker 402 corresponding to the person's arm, leg, torso, head, a portion therein, or a combination thereof.

The device-point scenario 410 can include starting position or orientation, ending position or orientation, duration for holding a position or orientation, speed, acceleration, direction, or a combination thereof for the movement of the user's hand. For example, the upward or horizontal movement of the hand can be distinguished for different commands. Also for example, a relatively constant rate of movement in a single direction, holding a position or orientation for a period of time, or a combination thereof can be used to distinguish a command from unrelated movements of the person.

For further example, the device-point scenario 410 can include a direction of movement for the device in user's hand relative to a direction of another device. The communication system 100 can recognize a command or a set of instructions corresponding to the device-point scenario 410 when the movement or the pointing motion involving a device is toward another device.

The device-point scenario 410 can include a duration for maintaining the shape, the orientation, or a combination thereof. The device-point scenario 410 can further include an angular threshold for orientation of the personal device 102 or the peripheral device 108 relative to the direction therefrom to the further targeted device. The device-point scenario 410 can also include conditions for one or more devices to be within a threshold distance from another device, conditions for the one or one or more devices to not contact the other device, or a combination thereof.

The device-tap scenario 412 is a representation of a set of movements of the person involving a hand and a contact between a set of devices. The device-tap scenario 412 can include the movement pattern 404 of one or more instances of the recognition marker 402 corresponding to a person's hand holding a device moving toward another device and causing contact between the two devices. The device-tap scenario 412 can include information representing contact, such as accelerometer readings, surface device readings, very short range communication detection, or a combination thereof.

The hand-raise scenario 414 is a representation of a set of movements of a person involving a hand, finger, arm, or a combination thereof relative to head, face, torso, or a combination thereof. The hand-raise scenario 414 can include the movement pattern 404 of one or more instances of the recognition marker 402 corresponding to a person's hand, arm, or a combination thereof moving upward relative to other instances of the recognition marker 402 corresponding to the person's torso, head, a portion therein, or a combination thereof. The hand-raise scenario 414 can further include starting position or orientation, ending position or orientation, speed, acceleration, direction, duration of position or orientation, or a combination thereof.

The content-slide scenario 416 is a representation of a set of linear movements of a hand, finger, or a combination thereof relative to multiple devices. The content-slide scenario 416 can include the movement pattern 404 of one or more instances of the recognition marker 402 corresponding to a person's hand, finger, or a combination thereof moving as an input corresponding to the content 302 on one device and in a direction toward a location of another device.

For example, the content-slide scenario 416 can include the individual user 205 contacting a touch-screen surface of the personal device 102 with the user's finger above a display of the content 302 and sliding the fingers on the touch-screen surface toward a physical location of the group-accommodation device 106 or the peripheral device 108. Also for example, the content-slide scenario 416 can include the individual user 205 making a grabbing or pinching motion above or in a direction corresponding to the content 302 on the group-accommodation device 106 and moving the hand toward the personal device 102 or the peripheral device 108 while maintaining the hand shape, orientation, or a combination thereof.

The point command scenario 418 is a representation of a hand, finger, or a combination thereof having a shape, an orientation, or a combination thereof relative to head, torso, or a combination thereof and one or more devices in the computing system 100. The point command scenario 418 can include the movement pattern 404 of one or more instances of the recognition maker 402 corresponding to a person's hand, finger, or a combination thereof having an arrangement representing a shape, an orientation, or a combination thereof for the hand, finger or a combination thereof.

The point command scenario 418 can include a duration for maintaining the shape, the orientation, or a combination thereof. The point command scenario 418 can further include a direction for the shape, the orientation, or a combination thereof relative to one or more device in the computing system 100.

The various scenarios can further include the context 308 for recognizing various commands. For example, the hand-raise scenario 414 can include the context 308 for a classroom setting based on time and location to activate or recognize the hand-raise scenario 414. Also for example, the context 308 of utilizing multiple connected screens based on an application or a specific device can be required to enable or identify the device-point scenario 410 or the content-slide scenario 416.

The various scenarios can be used to establish a connection between devices, transfer information between devices, modify settings or information determined by the computing system 100, or a combination thereof. Details regarding the use of the movement-command 406 will be discussed below.

The computing system 100 can establish a connection between devices, transfer information between devices, modify settings or information determined by the computing system 100, or a combination thereof with or without the direct-input 408. Details regarding the operation of the computing system 100 will be discussed below.

Referring now to FIG. 5, therein is shown an exemplary block diagram of the computing system 100. The computing system 100 can include the personal device 102, the communication path 104, and the group-accommodation device 106. The personal device 102 can send information in a first device transmission 508 over the communication path 104 to the group-accommodation device 106. The group-accommodation device 106 can send information in a second device transmission 510 over the communication path 104 to the personal device 102.

For illustrative purposes, the computing system 100 is shown with the personal device 102 and the group-accommodation device 106 as client devices, although it is understood that the computing system 100 can have the personal device 102 and the group-accommodation device 106 as different type of devices. For example, the personal device 102, the group-accommodation device 106, or a combination thereof can be a server having a display interface.

For brevity of description in this embodiment of the present invention, the personal device 102 and the group-accommodation device 106 will be described as client devices. The embodiment of the present invention is not limited to this selection for the type of devices. The selection is an example of an embodiment of the present invention.

The personal device 102 can include a first control unit 512, a first storage unit 514, a first communication unit 516, and a first user interface 518, and a location unit 520. The first control unit 512 can include a first control interface 522. The first control unit 512 can execute a first software 526 to provide the intelligence of the computing system 100.

The first control unit 512 can be implemented in a number of different manners. For example, the first control unit 512 can be a processor, an application specific integrated circuit (ASIC), an embedded processor, a microprocessor, a hardware control logic, a hardware finite state machine (FSM), a digital signal processor (DSP), or a combination thereof. The first control interface 522 can be used for communication between the first control unit 512 and other functional units in the personal device 102. The first control interface 522 can also be used for communication that is external to the personal device 102.

The first control interface 522 can receive information from the other functional units or from external sources, or can transmit information to the other functional units or to external destinations. The external sources and the external destinations refer to sources and destinations external to the personal device 102.

The first control interface 522 can be implemented in different ways and can include different implementations depending on which functional units or external units are being interfaced with the first control interface 522. For example, the first control interface 522 can be implemented with a pressure sensor, an inertial sensor, a microelectromechanical system (MEMS), optical circuitry, waveguides, wireless circuitry, wireline circuitry, or a combination thereof.

The first storage unit 514 can store the first software 526. The first storage unit 514 can also store the relevant information, such as data representing incoming images, data representing previously presented image, sound files, or a combination thereof.

The first storage unit 514 can be a volatile memory, a nonvolatile memory, an internal memory, an external memory, or a combination thereof. For example, the first storage unit 514 can be a nonvolatile storage such as non-volatile random access memory (NVRAM), Flash memory, disk storage, or a volatile storage such as static random access memory (SRAM).

The first storage unit 514 can include a first storage interface 524. The first storage interface 524 can be used for communication between the location unit 520 and other functional units in the personal device 102. The first storage interface 524 can also be used for communication that is external to the personal device 102.

The first storage interface 524 can receive information from the other functional units or from external sources, or can transmit information to the other functional units or to external destinations. The external sources and the external destinations refer to sources and destinations external to the personal device 102.

The first storage interface 524 can include different implementations depending on which functional units or external units are being interfaced with the first storage unit 514. The first storage interface 524 can be implemented with technologies and techniques similar to the implementation of the first control interface 522.

The first communication unit 516 can enable external communication to and from the personal device 102. For example, the first communication unit 516 can permit the personal device 102 to communicate with the group-accommodation device 106 of FIG. 1, the host device 110 of FIG. 1, an attachment, such as a peripheral device or a computer desktop, and the communication path 104.

The first communication unit 516 can also function as a communication hub allowing the personal device 102 to function as part of the communication path 104 and not limited to be an end point or terminal unit to the communication path 104. The first communication unit 516 can include active and passive components, such as microelectronics or an antenna, for interaction with the communication path 104.

The first communication unit 516 can include a first communication interface 528. The first communication interface 528 can be used for communication between the first communication unit 516 and other functional units in the personal device 102. The first communication interface 528 can receive information from the other functional units or can transmit information to the other functional units.

The first communication interface 528 can include different implementations depending on which functional units are being interfaced with the first communication unit 516. The first communication interface 528 can be implemented with technologies and techniques similar to the implementation of the first control interface 522.

The first user interface 518 allows a user (not shown) to interface and interact with the personal device 102. The first user interface 518 can include an input device and an output device. Examples of the input device of the first user interface 518 can include a keypad, a touchpad, soft-keys, a keyboard, a microphone, an infrared sensor for receiving remote signals, or any combination thereof to provide data and communication inputs.

The first user interface 518 can include a graphics processing unit (GPU) and a first display interface 530. The first display interface 530 can include a display, a projector, a video screen, a speaker, or any combination thereof. The first display interface 530 can include the display interface 202 of FIG. 2.

The first control unit 512 can operate the first user interface 518 to display information generated by the computing system 100. The first control unit 512 can also execute the first software 526 for the other functions of the computing system 100, including receiving location information from the location unit 520. The first control unit 512 can further execute the first software 526 for interaction with the communication path 104 via the first communication unit 516.

The location unit 520 can generate location information, current heading, current acceleration, and current speed of the personal device 102, as examples. The location unit 520 can be implemented in many ways. For example, the location unit 520 can function as at least a part of GPS, an inertial navigation system, a cellular-tower location system, a pressure location system, or any combination thereof. Also, for example, the location unit 620 can utilize components such as an accelerometer, a gyroscope, GPS receiver, or a combination thereof.

The location unit 520 can include a location interface 532. The location interface 532 can be used for communication between the location unit 520 and other functional units in the personal device 102. The location interface 632 can also be used for communication external to the personal device 102.

The location interface 532 can receive information from the other functional units or from external sources, or can transmit information to the other functional units or to external destinations. The external sources and the external destinations refer to sources and destinations external to the personal device 102.

The location interface 532 can include different implementations depending on which functional units or external units are being interfaced with the location unit 520. The location interface 532 can be implemented with technologies and techniques similar to the implementation of the first control unit 512.

The group-accommodation device 106 can be optimized for implementing an embodiment of the present invention in a multiple device embodiment with the personal device 102. The group-accommodation device 106 can provide the additional or higher performance processing power compared to the personal device 102. The group-accommodation device 106 can also provide optimized display interface compared to the personal device 102, such as a bigger screen or a higher definition. The group-accommodation device 106 can include a second control unit 534, a second communication unit 536, and a second user interface 538.

The second user interface 538 allows a user (not shown) to interface and interact with the group-accommodation device 106. The second user interface 538 can include an input device and an output device. Examples of the input device of the second user interface 538 can include a keypad, a touchpad, touch screen, soft-keys, a keyboard, a microphone, or any combination thereof to provide data and communication inputs. Examples of the output device of the second user interface 538 can include a second graphics processing unit and a second display interface 540. The second display interface 540 can include a display, a projector, a video screen, a speaker, or any combination thereof. The second display interface 540 can also include the further display 204 of FIG. 2.

The second control unit 534 can execute a second software 542 to provide the intelligence of the group-accommodation device 106 of the computing system 100. The second software 542 can operate in conjunction with the first software 526. The second control unit 534 can provide additional performance compared to the first control unit 512.

The second control unit 534 can operate the second user interface 538 to display information. The second control unit 534 can also execute the second software 542 for the other functions of the computing system 100, including operating the second communication unit 536 to communicate with the personal device 102, the host device 110, or a combination thereof over the communication path 104.

The second control unit 534 can be implemented in a number of different manners. For example, the second control unit 534 can be a processor, an application specific integrated circuit (ASIC), an embedded processor, a microprocessor, hardware control logic, a hardware finite state machine (FSM), a digital signal processor (DSP), or a combination thereof.

The second control unit 534 can include a second controller interface 544. The second controller interface 544 can be used for communication between the second control unit 534 and other functional units in the group-accommodation device 106. The second controller interface 544 can also be used for communication that is external to the group-accommodation device 106.

The second controller interface 544 can receive information from the other functional units or from external sources, or can transmit information to the other functional units or to external destinations. The external sources and the external destinations refer to sources and destinations external to the group-accommodation device 106.

The second controller interface 544 can be implemented in different ways and can include different implementations depending on which functional units or external units are being interfaced with the second controller interface 544. For example, the second controller interface 544 can be implemented with a pressure sensor, an inertial sensor, a microelectromechanical system (MEMS), optical circuitry, waveguides, wireless circuitry, wireline circuitry, or a combination thereof.

A second storage unit 546 can store the second software 542. The second storage unit 546 can also store the such as data representing incoming images, data representing previously presented image, sound files, or a combination thereof. The second storage unit 546 can be sized to provide the additional storage capacity to supplement the first storage unit 514.

For illustrative purposes, the second storage unit 546 is shown as a single element, although it is understood that the second storage unit 546 can be a distribution of storage elements. Also for illustrative purposes, the computing system 100 is shown with the second storage unit 546 as a single hierarchy storage system, although it is understood that the computing system 100 can have the second storage unit 546 in a different configuration. For example, the second storage unit 546 can be formed with different storage technologies forming a memory hierarchal system including different levels of caching, main memory, rotating media, or off-line storage.

The second storage unit 546 can be a volatile memory, a nonvolatile memory, an internal memory, an external memory, or a combination thereof. For example, the second storage unit 546 can be a nonvolatile storage such as non-volatile random access memory (NVRAM), Flash memory, disk storage, or a volatile storage such as static random access memory (SRAM).

The second storage unit 546 can include a second storage interface 548. The second storage interface 548 can be used for communication between other functional units in the group-accommodation device 106. The second storage interface 548 can also be used for communication that is external to the group-accommodation device 106.

The second storage interface 548 can receive information from the other functional units or from external sources, or can transmit information to the other functional units or to external destinations. The external sources and the external destinations refer to sources and destinations external to the group-accommodation device 106.

The second storage interface 548 can include different implementations depending on which functional units or external units are being interfaced with the second storage unit 546. The second storage interface 548 can be implemented with technologies and techniques similar to the implementation of the second controller interface 544.

The second communication unit 536 can enable external communication to and from the group-accommodation device 106. For example, the second communication unit 536 can permit the group-accommodation device 106 to communicate with the personal device 102 over the communication path 104.

The second communication unit 536 can also function as a communication hub allowing the group-accommodation device 106 to function as part of the communication path 104 and not limited to be an end point or terminal unit to the communication path 104. The second communication unit 536 can include active and passive components, such as microelectronics or an antenna, for interaction with the communication path 104.

The second communication unit 536 can include a second communication interface 550. The second communication interface 550 can be used for communication between the second communication unit 536 and other functional units in the group-accommodation device 106. The second communication interface 550 can receive information from the other functional units or can transmit information to the other functional units.

The second communication interface 550 can include different implementations depending on which functional units are being interfaced with the second communication unit 536. The second communication interface 550 can be implemented with technologies and techniques similar to the implementation of the second controller interface 544.

The first communication unit 516 can couple with the communication path 104 to send information to the group-accommodation device 106 in the first device transmission 508. The group-accommodation device 106 can receive information in the second communication unit 536 from the first device transmission 508 of the communication path 104.

The second communication unit 536 can couple with the communication path 104 to send information to the personal device 102 in the second device transmission 510. The personal device 102 can receive information in the first communication unit 516 from the second device transmission 510 of the communication path 104. The computing system 100 can be executed by the first control unit 512, the second control unit 534, or a combination thereof.

The personal device 102, the group-accommodation device 106, or a combination thereof can similarly communicate and interact with the host device 110. Details for the host device 110 will be described below.

For illustrative purposes, the group-accommodation device 106 is shown with the partition having the second user interface 538, the second storage unit 546, the second control unit 534, and the second communication unit 536, although it is understood that the group-accommodation device 106 can have a different partition. For example, the second software 542 can be partitioned differently such that some or all of its function can be in the second control unit 534 and the second communication unit 536. Also, the group-accommodation device 106 can include other functional units not shown in FIG. 5 for clarity.

The functional units in the personal device 102 can work individually and independently of the other functional units. The personal device 102 can work individually and independently from the group-accommodation device 106, the host device 110, and the communication path 104.

The functional units in the group-accommodation device 106 can work individually and independently of the other functional units. The group-accommodation device 106 can work individually and independently from the personal device 102, the host device 110, and the communication path 104.

For illustrative purposes, the computing system 100 is described by operation of the personal device 102 and the group-accommodation device 106. It is understood that the personal device 102, the group-accommodation device 106, and the host device 110 can operate any of the modules and functions of the computing system 100.

Referring now to FIG. 6, therein is shown a further exemplary block diagram of the computing system 100. Along with the personal device 102, the host device 110 of FIG. 1, and the group-accommodation device 106 of FIG. 5, the computing system 100 can include the peripheral device 108. The personal device 102 can send information in the first device transmission over the communication path 104 to the peripheral device 108. The peripheral device 108 can send information in a third device transmission 610 over the communication path 104 to the personal device 102.

For illustrative purposes, the computing system 100 is shown with the peripheral device 108 as a server, although it is understood that the computing system 100 can have the peripheral device 108 as a different type of device. For example, the peripheral device 108 can be a client device.

Also for illustrative purposes, the computing system 100 is shown with the personal device 102 communicating with the peripheral device 108. However, it is understood that the group-accommodation device 106, the host device 110 of FIG. 1, or a combination thereof can also communicate with the peripheral device 108 in a similar manner as between the personal device 102 and the group-accommodation device 106.

For brevity of description in this embodiment of the present invention, the peripheral device 108 will be described as a client device. The embodiment of the present invention is not limited to this selection for the type of devices. The selection is an example of an embodiment of the present invention.

The peripheral device 108 can be optimized for implementing an embodiment of the present invention in a multiple device embodiment with the personal device 102. The peripheral device 108 can provide the additional or higher performance processing power compared to the personal device 102, the group-accommodation device 106, or a combination thereof. The peripheral device 108 can include a third control unit 634, a third communication unit 636, and a third user interface 638.

The third user interface 638 allows a user (not shown) to interface and interact with the peripheral device 108. The third user interface 638 can include an input device and an output device. Examples of the input device of the third user interface 638 can include a keypad, a touchpad, touch screen, soft-keys, a keyboard, a microphone, or any combination thereof to provide data and communication inputs. Examples of the output device of the third user interface 638 can include a third display interface 640. The third display interface 640 can include a display, a projector, a video screen, a speaker, or any combination thereof.

The third control unit 634 can execute a third software 642 to provide the intelligence of the peripheral device 108 of the computing system 100. The third software 642 can operate in conjunction with the first software 526, the second software 542 of FIG. 5, or a combination thereof. The third control unit 634 can provide additional performance compared to the first control unit 512.

The third control unit 634 can operate the third user interface 638 to display information. The third control unit 634 can also execute the third software 642 for the other functions of the computing system 100, including operating the third communication unit 636 to communicate with the personal device 102, the group-accommodation device 106, or a combination thereof over the communication path 104.

The third control unit 634 can be implemented in a number of different manners. For example, the third control unit 634 can be a processor, an application specific integrated circuit (ASIC), an embedded processor, a microprocessor, hardware control logic, a hardware finite state machine (FSM), a digital signal processor (DSP), or a combination thereof.

The third control unit 634 can include a third controller interface 644. The third controller interface 644 can be used for communication between the third control unit 634 and other functional units in the peripheral device 108. The third controller interface 644 can also be used for communication that is external to the peripheral device 108.

The third controller interface 644 can receive information from the other functional units or from external sources, or can transmit information to the other functional units or to external destinations. The external sources and the external destinations refer to sources and destinations external to the peripheral device 108.

The third controller interface 644 can be implemented in different ways and can include different implementations depending on which functional units or external units are being interfaced with the third controller interface 644. For example, the third controller interface 644 can be implemented with a pressure sensor, an inertial sensor, a microelectromechanical system (MEMS), optical circuitry, waveguides, wireless circuitry, wireline circuitry, or a combination thereof.

A third storage unit 646 can store the third software 642. The third storage unit 646 can also store the such as data representing incoming images, data representing previously presented image, sound files, or a combination thereof. The third storage unit 646 can be sized to provide the additional storage capacity to supplement the first storage unit 514.

For illustrative purposes, the third storage unit 646 is shown as a single element, although it is understood that the third storage unit 646 can be a distribution of storage elements. Also for illustrative purposes, the computing system 100 is shown with the third storage unit 646 as a single hierarchy storage system, although it is understood that the computing system 100 can have the third storage unit 646 in a different configuration. For example, the third storage unit 646 can be formed with different storage technologies forming a memory hierarchal system including different levels of caching, main memory, rotating media, or off-line storage.

The third storage unit 646 can be a volatile memory, a nonvolatile memory, an internal memory, an external memory, or a combination thereof. For example, the third storage unit 646 can be a nonvolatile storage such as non-volatile random access memory (NVRAM), Flash memory, disk storage, or a volatile storage such as static random access memory (SRAM).

The third storage unit 646 can include a third storage interface 648. The third storage interface 648 can be used for communication between other functional units in the peripheral device 108. The third storage interface 648 can also be used for communication that is external to the peripheral device 108.

The third storage interface 648 can receive information from the other functional units or from external sources, or can transmit information to the other functional units or to external destinations. The external sources and the external destinations refer to sources and destinations external to the peripheral device 108.

The third storage interface 648 can include different implementations depending on which functional units or external units are being interfaced with the third storage unit 646. The third storage interface 648 can be implemented with technologies and techniques similar to the implementation of the third controller interface 644.

The third communication unit 636 can enable external communication to and from the peripheral device 108. For example, the third communication unit 636 can permit the peripheral device 108 to communicate with the personal device 102, the group-accommodation device 106, or a combination thereof over the communication path 104.

The third communication unit 636 can also function as a communication hub allowing the peripheral device 108 to function as part of the communication path 104 and not limited to be an end point or terminal unit to the communication path 104. The third communication unit 636 can include active and passive components, such as microelectronics or an antenna, for interaction with the communication path 104.

The third communication unit 636 can include a third communication interface 650. The third communication interface 650 can be used for communication between the third communication unit 636 and other functional units in the peripheral device 108. The third communication interface 650 can receive information from the other functional units or can transmit information to the other functional units.

The third communication interface 650 can include different implementations depending on which functional units are being interfaced with the third communication unit 636. The third communication interface 650 can be implemented with technologies and techniques similar to the implementation of the third controller interface 644.

The first communication unit 516 can couple with the communication path 104 to send information to the peripheral device 108 in the first device transmission 508. The peripheral device 108 can receive information in the third communication unit 636 from the first device transmission 508 of the communication path 104.

The third communication unit 636 can couple with the communication path 104 to send information to the personal device 102 in the third device transmission 610. The personal device 102 can receive information in the first communication unit 516 from the third device transmission 610 of the communication path 104. The computing system 100 can be executed by the first control unit 512, the third control unit 634, or a combination thereof. The group-accommodation device 106 can similarly communicate and interact with the peripheral device 108 using the corresponding units and functions therein.

For illustrative purposes, the peripheral device 108 is shown with the partition having the third user interface 638, the third storage unit 646, the third control unit 634, and the third communication unit 636, although it is understood that the peripheral device 108 can have a different partition. For example, the third software 642 can be partitioned differently such that some or all of its function can be in the third control unit 634 and the third communication unit 636. Also, the peripheral device 108 can include other functional units not shown in FIG. 6 for clarity.

The functional units in the peripheral device 108 can work individually and independently of the other functional units. The peripheral device 108 can work individually and independently from the personal device 102, the group-accommodation device 106, the host device 110, and the communication path 104.

For illustrative purposes, the computing system 100 is described by operation of the personal device 102 and the peripheral device 108. It is understood that the personal device 102, the group-accommodation device 106, the host device 110, and the peripheral device 108 can operate any of the modules and functions of the computing system 100.

Referring now to FIG. 7, therein is shown a further exemplary block diagram of the computing system 100. Along with the personal device 102, the peripheral device 108 of FIG. 6 and the group-accommodation device 106 of FIG. 5, the computing system 100 can include the host device 110. The personal device 102 can send information in the first device transmission over the communication path 104 to the host device 110. The host device 110 can send information in a host device transmission 710 over the communication path 104 to the personal device 102.

For illustrative purposes, the computing system 100 is shown with the host device 110 as a server, although it is understood that the computing system 100 can have the host device 110 as a different type of device. For example, the host device 110 can be a client device.

Also for illustrative purposes, the computing system 100 is shown with the personal device 102 communicating with the host device 110. However, it is understood that the group-accommodation device 106, the peripheral device 108, or a combination thereof can also communicate with the host device 110 in a similar manner as the communication between the personal device 102 and the group-accommodation device 106.

For brevity of description in this embodiment of the present invention, the host device 110 will be described as a server device. The embodiment of the present invention is not limited to this selection for the type of devices. The selection is an example of an embodiment of the present invention.

The host device 110 can be optimized for implementing an embodiment of the present invention in a multiple device embodiment with the personal device 102. The host device 110 can provide the additional or higher performance processing power compared to the personal device 102, the group-accommodation device 106, or a combination thereof. The host device 110 can include a host control unit 734, a host communication unit 736, and a host user interface 738.

The host user interface 738 allows a user (not shown) to interface and interact with the host device 110. The host user interface 738 can include an input device and an output device. Examples of the input device of the host user interface 738 can include a keypad, a touchpad, touch screen, soft-keys, a keyboard, a microphone, or any combination thereof to provide data and communication inputs. Examples of the output device of the host user interface 738 can include a host display interface 740. The host display interface 740 can include a display, a projector, a video screen, a speaker, or any combination thereof.

The host control unit 734 can execute a host software 742 to provide the intelligence of the host device 110 of the computing system 100. The host software 742 can operate in conjunction with the first software 526, the second software 542 of FIG. 5, or a combination thereof. The host control unit 734 can provide additional performance compared to the first control unit 512.

The host control unit 734 can operate the host user interface 738 to display information. The host control unit 734 can also execute the host software 742 for the other functions of the computing system 100, including operating the host communication unit 736 to communicate with the personal device 102, the group-accommodation device 106, or a combination thereof over the communication path 104.

The host control unit 734 can be implemented in a number of different manners. For example, the host control unit 734 can be a processor, an application specific integrated circuit (ASIC), an embedded processor, a microprocessor, hardware control logic, a hardware finite state machine (FSM), a digital signal processor (DSP), or a combination thereof.

The host control unit 734 can include a host controller interface 744. The host controller interface 744 can be used for communication between the host control unit 734 and other functional units in the host device 110. The host controller interface 744 can also be used for communication that is external to the host device 110.

The host controller interface 744 can receive information from the other functional units or from external sources, or can transmit information to the other functional units or to external destinations. The external sources and the external destinations refer to sources and destinations external to the host device 110.

The host controller interface 744 can be implemented in different ways and can include different implementations depending on which functional units or external units are being interfaced with the host controller interface 744. For example, the host controller interface 744 can be implemented with a pressure sensor, an inertial sensor, a microelectromechanical system (MEMS), optical circuitry, waveguides, wireless circuitry, wireline circuitry, or a combination thereof.

A host storage unit 746 can store the host software 742. The host storage unit 746 can also store the such as data representing incoming images, data representing previously presented image, sound files, or a combination thereof. The host storage unit 746 can be sized to provide the additional storage capacity to supplement the first storage unit 514.

For illustrative purposes, the host storage unit 746 is shown as a single element, although it is understood that the host storage unit 746 can be a distribution of storage elements. Also for illustrative purposes, the computing system 100 is shown with the host storage unit 746 as a single hierarchy storage system, although it is understood that the computing system 100 can have the host storage unit 746 in a different configuration. For example, the host storage unit 746 can be formed with different storage technologies forming a memory hierarchal system including different levels of caching, main memory, rotating media, or off-line storage.

The host storage unit 746 can be a volatile memory, a nonvolatile memory, an internal memory, an external memory, or a combination thereof. For example, the host storage unit 746 can be a nonvolatile storage such as non-volatile random access memory (NVRAM), Flash memory, disk storage, or a volatile storage such as static random access memory (SRAM).

The host storage unit 746 can include a host storage interface 748. The host storage interface 748 can be used for communication between other functional units in the host device 110. The host storage interface 748 can also be used for communication that is external to the host device 110.

The host storage interface 748 can receive information from the other functional units or from external sources, or can transmit information to the other functional units or to external destinations. The external sources and the external destinations refer to sources and destinations external to the host device 110.

The host storage interface 748 can include different implementations depending on which functional units or external units are being interfaced with the host storage unit 746. The host storage interface 748 can be implemented with technologies and techniques similar to the implementation of the host controller interface 744.

The host communication unit 736 can enable external communication to and from the host device 110. For example, the host communication unit 736 can permit the host device 110 to communicate with the personal device 102, the group-accommodation device 106, or a combination thereof over the communication path 104.

The host communication unit 736 can also function as a communication hub allowing the host device 110 to function as part of the communication path 104 and not limited to be an end point or terminal unit to the communication path 104. The host communication unit 736 can include active and passive components, such as microelectronics or an antenna, for interaction with the communication path 104.

The host communication unit 736 can include a host communication interface 750. The host communication interface 750 can be used for communication between the host communication unit 736 and other functional units in the host device 110. The host communication interface 750 can receive information from the other functional units or can transmit information to the other functional units.

The host communication interface 750 can include different implementations depending on which functional units are being interfaced with the host communication unit 736. The host communication interface 750 can be implemented with technologies and techniques similar to the implementation of the host controller interface 744.

The first communication unit 516 can couple with the communication path 104 to send information to the host device 110 in the first device transmission 508. The host device 110 can receive information in the host communication unit 736 from the first device transmission 508 of the communication path 104.

The host communication unit 736 can couple with the communication path 104 to send information to the personal device 102 in the host device transmission 710. The personal device 102 can receive information in the first communication unit 516 from the host device transmission 710 of the communication path 104. The computing system 100 can be executed by the first control unit 512, the host control unit 734, or a combination thereof. The group-accommodation device 106 can similarly communicate and interact with the host device 110 using the corresponding units and functions therein.

For illustrative purposes, the host device 110 is shown with the partition having the host user interface 738, the host storage unit 746, the host control unit 734, and the host communication unit 736, although it is understood that the host device 110 can have a different partition. For example, the host software 742 can be partitioned differently such that some or all of its function can be in the host control unit 734 and the host communication unit 736. Also, the host device 110 can include other functional units not shown in FIG. 7 for clarity.

The functional units in the host device 110 can work individually and independently of the other functional units. The host device 110 can work individually and independently from the personal device 102, the group-accommodation device 106, the peripheral device 108, and the communication path 104.

For illustrative purposes, the computing system 100 is described by operation of the personal device 102 and the host device 110. It is understood that the personal device 102, the group-accommodation device 106, the peripheral device 108, and the host device 110 can operate any of the modules and functions of the computing system 100.

Referring now to FIG. 8, therein is shown a control flow of the computing system 100. The computing system 100 can include a profile module 802, an identification module 804, a context module 806, a networking module 808, a management module 810, and a command module 812.

The profile module 802 can be coupled to the identification module 804 using wired or wireless connections, by having an output of one module as an input of the other module, by having operations of one module influence operation of the other module, or a combination thereof. Similarly the identification module 804 can be coupled to the context module 806, and the context module 806 can be coupled to the networking module 808. Also, the networking module 808 can be coupled to the management module 810 and the command module 812.

The profile module 802 is configured to initialize and manage the access profile 204 of FIG. 2. The profile module 802 can be configured to initialize various profiles, such as the individual-member profile 206 of FIG. 2 or the further-member profile 208 of FIG. 2, corresponding to individual users.

The profile module 802 can use the first user interface 518 of FIG. 5, the second user interface 538 of FIG. 5, the third user interface 638 of FIG. 6, the host user interface 738 of FIG. 7, or a combination thereof to initialize the various profiles. For example, the profile module 802 can interact with the individual user 205 of FIG. 2 using a camera, a microphone, or a combination thereof on the personal device 102 of FIG. 1, the group-accommodation device 106 of FIG. 1, the peripheral device 108 of FIG. 1, the host device 110 of FIG. 1, or a combination thereof to set the physical identification signature 210 of FIG. 2 associated with the individual user 205.

The profile module 802 can further use the first display interface 530 of FIG. 5, the second display interface 540 of FIG. 5, the third display interface 640 of FIG. 6, the host display interface 740 of FIG. 7, or a combination thereof to display the access profile 204 or the details therein. The profile module 802 can further use the interfaces and displays to interact with the individual user 205 to determine and initialize the device association 212 of FIG. 2, the access level 214 of FIG. 2, the recommendation preference 218 of FIG. 2, the device-use preference 220 of FIG. 2, or a combination thereof.

The profile module 802 can further use the initialization-recognition factor 318 of FIG. 3 to initialize the device association 212. The profile module 802 can match data acquired through the first user interface 518, the second user interface 538, the third user interface 638, the host user interface 738, the first communication unit 516 of FIG. 5, the second communication unit 536 of FIG. 5, the third communication unit 636 of FIG. 6, the host communication unit 736 of FIG. 7, or a combination thereof to the initialization-recognition factor 318.

When the data matches the initialization-recognition factor 318, the profile module 802 can set the device-identification 228 of FIG. 2 to the identity of the device in the data. The profile module 802 can further associate ownership of the device to the individual user 205 identified by the physical identification signature 210 through the ownership-rating 230 of FIG. 2 based on identifying the initialization-recognition factor 318 in the data.

For example, the profile module 802 can receive data regarding the individual user 205 opening a box containing a new device, detect initialization screen on the new device, detect transmission or submission of registration data for the new device, receive logging or networking information regarding the new device, or a combination thereof. The profile module 802 can identify the data listed above as specifying ownership or initialization of the device through the initialization-recognition factor 318.

Continuing with the example, the profile module 802 can determine the identity of the individual user 205 performing the action through the physical identification signature 210. The profile module 802 can specify that the individual user 205 owns the new device through the device association 212 without the direct-input 408 from any user specifying such relationship.

The profile module 802 can further be configured to generate the device-use preference 220 for displaying the personalized material 314 of FIG. 3, the content 302 of FIG. 3, or a combination thereof across the personal device 102, the group-accommodation device 106, the peripheral device 108, or a combination thereof. The profile module 802 can use the direct-input 408 from the individual user 205 corresponding to the individual-member profile 206 to set the device-use preference 220.

The profile module 802 can also generate the device-use preference 220 using previous settings of the individual user 205, demographic information of the individual user 205, common settings or uses for individual device, metadata for the personalized material 314 or the content 302, or a combination thereof. For example, the profile module 802 can recall that the individual user 205 prefers having subtitles or replay features available on the personal device 102, character profiles on the peripheral device 108, specific sound and pictures settings on the group-accommodation device 106, or a combination thereof when watching a movie having “drama” categorization on the group-accommodation device 106.

Continuing with the example, the profile module 802 can generate the device-use preference 220 by storing the previous settings or storing a result of averaging the previous settings, commonly used settings of the individual user 205, or a combination thereof. Also for example, the profile module 802 can generate the device-use preference 220 by identifying a device setting common for demographics of the individual user 205 or common for a specific combination of devices in the device-grouping 304 of FIG. 3.

Continuing with the example, the profile module 802 can have various settings and combinations of user demographics and devices predetermined by the computing system 100. The profile module 802 can use the various settings and combinations stored in the first storage unit 514 of FIG. 5, the second storage unit 546 of FIG. 5, the third storage unit 646 of FIG. 6, the host storage unit 746 of FIG. 7, or a combination thereof to generate the device-use preference 220.

The profile module 802 can also set the access level 214 for the individual user 205. The profile module 802 can set the access level 214 to the complete-access 232 of FIG. 2 through specific interface, such as proof of ownership or registration of a specific device. For example, the profile module 802 can identify a purchasing receipt, passcode, identification, or a combination thereof from a mother of the house or a team lead to set the access level 214 to the complete-access 232 for the mother or the team lead.

For further example, the profile module 802 can assign the complete-access 232 to the individual user 205 registering the new device or initializing a networking feature of the new device. Also for example, the profile module 802 can allow users having the complete-access 232 to assign the complete-access 232 to other users.

The profile module 802 can include an adjustment module 814. The adjustment module 814 is configured to adjust the individual-member profile 206, including the access profile 204. Details regarding the adjustment module 814 will be discussed below.

After initializing the access profile 204, the control flow can pass from the profile module 802 to the identification module 804. The control flow can pass by having the access profile 204 or a portion therein as an output from the profile module 802 to an input for the identification module 804, storing the access profile 204 at a location known and accessible to the identification module 804, by notifying the identification module 804, such as by using a flag, an interrupt, a status signal, or a combination thereof, or a combination of processes thereof.

The identification module 804 configured to identify the individual user 205 through physical traits of the individual user 205, a device belonging to the individual user 205, or a combination thereof. The identification module 804 can include a trait-recognition module 816 and a device-recognition module 818.

The trait-recognition module 816 is configured to detect the physical identification signature 210 for representing the individual user 205. The trait-recognition module 816 can analyze data from the first user interface 518, the second user interface 538, the third user interface 638, the host user interface 738, the first control unit 512 of FIG. 5, the second control unit 534 of FIG. 5, the third control unit 634 of FIG. 6, the host control unit 734 of FIG. 7, or a combination thereof to detect the data corresponding to or matching the physical identification signature 210 of the individual user 205.

For example, the trait-recognition module 816 can recognize the individual user 205 by matching sound input from a microphone and the auditory signature 224 of FIG. 2 using one or more user interfaces. Also for example, the trait-recognition module 816 can recognize the individual user 205 by using one or more control units to match input from one or more cameras from the various devices and the appearance signature 222 of FIG. 2, the motion signature 226 of FIG. 2, or a combination thereof.

The device-recognition module 818 is configured to detect a device belonging to and closely associated with the individual user 205. The device-recognition module 818 can be configured to detect the device-identification 228.

The device-recognition module 818 can detect the device-identification 228 by polling for or initiating communication with new devices according to a protocol predetermined by the computing system 100. The device-recognition module 818 can detect the device-identification 228 when the first communication unit 516 of FIG. 5, the second communication unit 536 of FIG. 5, the third communication unit 636 of FIG. 6, the host communication unit 736 of FIG. 7, or a combination thereof receives identification information from the new device matching the device-identification 228.

The identification module 804 can recognize the individual user 205 based on detection of the physical identification signature 210 and the device-identification 228. The identification module 804 can determine that the individual user 205 is present when the physical identification signature 210 and the device-identification 228 are included in same instance of the individual-member profile 206 corresponding to the individual user 205.

The identification module 804 can further recognize the individual user 205 based on the ownership-rating 230 describing the relationship between the individual user 205 and the device detected by the device-identification 228. The identification module 804 can recognize the individual user 205 when the ownership-rating 230 corresponding to the detected device represents ownership, control, and typical use that are personal in nature and often closely associated with the identity and the person of the individual user 205. The identification module 804 can recognize the individual user 205 by recognizing the personal device 102 that the individual user 205 would carry, wear, use, or a combination thereof throughout most of the day.

For example, the identification module 804 can recognize the individual user 205 when the device-recognition module 818 detects the personal device 102 belonging to the individual user 205, with the personal device 102 having the ownership-rating 230 representing a close association with the individual user 205. Also for example, the identification module 804 can withhold from identifying the individual user 205 when the device-recognition module 818 detects devices having the ownership-rating 230 representing shared devices, such as a family computer or a guest machine, or devices that are often not associated with ownership, control, typical use, or a combination thereof for the individual user 205.

The identification module 804 can use the first control unit 512, the second control unit 534, the third control unit 634, the host control unit 734, or a combination thereof to identify the individual user 205 with the physical identification signature 210 and the device association 212. The identification module 804 can store the identity of the individual user 205, the associated instance of the individual-member profile 206, the physical identification signature 210, the device association 212, or a combination thereof in the first storage unit 514, the second storage unit 546, the third storage unit 646, the host storage unit 746, or a combination thereof.

The identification module 804 can be used with the profile module 802 to initialize the individual-member profile 206. For example, information regarding physical traits or device information detected by the identification module 804 can be used by the profile module 802 to initialize one or more components in the individual-member profile 206. Also for example, input data physical traits or device information can be used to train the profile module 802, the identification module 804, or a combination thereof to recognize and identify the individual user 205.

The identification module 804 can further be used with the adjustment module 814 to adjust the individual-member profile 206. Details regarding the adjustment process will be discussed below.

It has been discovered that the combination of the physical identification signature 210 and the device association 212 provide improved accuracy in identifying the individual user 205. The device association 212 allow the computing system 100 to utilize usage models of devices being closely associated with identity of users, which can be verified by the physical identification signature 210. The added level of identification using both devise and physical traits increase the accuracy of identifying users.

After identifying the individual user 205 and the corresponding instance of the individual-member profile 206, the control flow can pass to the context module 806. The control flow can pass similarly as described above between the profile module 802 and the identification module 804 with the individual-member profile 206 or elements therein, notifications, or a combination thereof.

The context module 806 is configured to determine the context 308 of FIG. 3. The context module 806 can determine the context 308 by identifying the contextual factor 310 of FIG. 3. For example, the context module 806 can identify, current time, current location, association or relationship between users identified by the computing system 100, previously engaged activities of the individual user 205, event or significance associated therewith, or a combination thereof.

As a more specific example, the context module 806 can use the first control unit 512, the second control unit 534, the third control unit 634, the host control unit 734, or a combination thereof to search social networking database or user calendar to determine relationships between detected users, such as family or coworker. Also as an example, the context module 806 can use the first communication unit 516, the second communication unit 536, the third communication unit 636, the host communication unit 736, or a combination thereof to search for the content 302 having special significance or limited availability, such as broadcasts for historic events or material having expiring license or availability, or information attributing special significance to the date or time.

The context module 806 can use profile information or previous history information, including the content history 312, of the individual user 205 to determine the context 308. For example, the context module 806 can determine that the individual user 205 matching a specific demographic information set would likely attribute significance to major sporting events. Also for example, the context module 806 can determine that the individual user 205 who blogs about major sporting events, has previously entered calendar events regarding major sporting events, has watched, attended, or engaged in a corresponding sport would likely attribute significance to major sporting events.

The context module 806 can determine the context 308 when the individual user 205 is detected and identified by the identification module 804. The context module 806 can be configured to determine the context 308 associated with detecting the physical identification signature 210 and the device-identification 228.

The context module 806 can determine the context 308 specifically linked to when one or more user is detected and identified by the computing system 100. The context module 806 can search input data, available data, or a combination thereof for the contextual factor 310 when the when one or more user is detected and identified by the identification module 804. The context module 806 can compare the contextual factor 310 to sets of information predetermined by the computing system 100. The context module 806 can assign values associated with one or more sets of predetermined information matching the contextual factor 310 as the context 308.

The context module 806 can further determine the context 308 for security related situations. For example, the context module 806 can be configured to determine a security breach 820 based on the physical identification signature 210, the device-identification 228, or a combination thereof for transmitting the physical identification signature 210, the device-identification 228, or a combination thereof.

The security breach 820 is a representation of a situation or condition where the individual user 205 needs to be contacted for safety reasons. The security breach 820 can be a status or a flag for situations where unidentified user is detected with specific instance of the context 308.

For example, the security breach 820 can be when the physical identification signature 210, the device-identification 228, or a combination thereof detected by the identification module 804 does not match any of the profiles within the access profile 204. Also for example, the security breach 820 can further include the context 308 of working hours for residents of the house without any appointments or notifications in the residents' calendars.

The context module 806 can store the physical identification signature 210, captured sound or image, the device-identification 228, communication information with the unidentified device, or a combination thereof in the first storage unit 514, the second storage unit 546, the third storage unit 646, the host storage unit 746, or a combination thereof when the security breach 820 is detected. The context module 806 can further use the first communication unit 516, the second communication unit 536, the third communication unit 636, the host communication unit 736, or a combination thereof to transmit the physical identification signature 210, captured sound or image, the device-identification 228, communication information with the unidentified device, or a combination thereof to the individual user 205, law enforcement authority, security service provider, or a combination thereof.

After determining the context 308, the control flow can pass to the networking module 808. The control flow can pass similarly as described above between the profile module 802 and the identification module 804 using the context 308, notifications, or a combination thereof.

The networking module 808 is configured to enable and control access for the individual user 205 across multiple devices. The networking module 808 can include a connection module 822, an access control module 824, and a history module 826 for enabling and controlling access for one or more users across multiple devices.

The connection module 822 is configured to connect multiple devices. The connection module 822 can be configured to establish the device-grouping 304. The connection module 822 can establish the device-grouping 304 for connecting a combination of the personal device 102, the group-accommodation device 106, the peripheral device 108, and the host device 110. The connected devices can be used to display the content 302.

The connection module 822 can establish the device-grouping 304 with or without the direct-input 408 based on the physical identification signature 210, the device-identification 228, the context 308, or a combination thereof. The connection module 822 can use the first communication unit 516, the second communication unit 536, the third communication unit 636, the host communication unit 736, or a combination thereof to establish the device-grouping 304. The connection module 822 can further utilize protocols predetermined by the computing system 100 to establish the device-grouping 304 for multiple devices.

The connection module 822 can establish the device-grouping 304 with a particular device based on identifying the individual user 205 having the particular device using a corresponding instance of the individual-member profile 206. The connection module 822 can establish the device-grouping 304 based on results of the identification module 804 associated with the physical identification signature 210 and the device association 212 corresponding to the individual user 205 and the particular device.

The connection module 822 can further establish the device-grouping 304 based on the context 308. The connection module 822 can include predetermined instances of the context 308 for establishing the device-grouping 304. The predetermined instances of the context 308 can be established by the computing system 100 and stored in the first storage unit 514, the second storage unit 546, the third storage unit 646, the host storage unit 746, or a combination thereof.

The connection module 822 can use the first control unit 512, the second control unit 534, the third control unit 634, the host control unit 734, or a combination thereof to compare the determined instance of the context 308 from the context module 806 to the predetermined instances. The connection module 822 can establish the device-grouping 304 when the predetermined instances indicate that the device-grouping 304 is appropriate.

For example, the connection module 822 can establish the device-grouping 304 for the individual user 205 having security clearance level or identifiable need-to-know corresponding to the individual-member profile 206 and associated with the context 308. Also for example, the connection module 822 can establish the device-grouping 304 when the context 308 represents some level of privacy, includes one or more features involving sharing or personalizing, or a combination thereof.

The connection module 822 can determine one or a combination of devices as a main controller for controlling the device-grouping 304. For example, the connection module 822 can establish the personal device 102, the group-accommodation device 106, the peripheral device 108, the host device 110, or a combination thereof as the main controller.

The connection module 822 can determine the main controller based on preferences or scores. The connection module 822 can have methods predetermined by the computing system 100 for determining the main controller from various groupings of available devices. The connection module 822 can determine the main controller based on device capabilities, such as by selecting the device having the most powerful camera or highest processing capability.

The connection module 822 can further determine the main controller based on the context 308, the device association 212, or a combination thereof. For example, the connection module 822 can select the device that is most stable or the biggest amongst the available devices for establishing a more stable location for the device-grouping 304 with respect to the context 308. Also for example, the connection module 822 can select devices belonging to a resident or owner associated with the location as indicated by the context 308.

The connection module 822 can further establish the device-grouping 304, determine the main controller, or a combination thereof only when a specific device is detected. For example, the connection module 822 can establish the device-grouping 304 only when the group-accommodation device 106 detects smart phones, laptops, tablets, or a combination thereof, when a television or a projector is detected by the personal device 102, or a combination of detections thereof.

The connection module 822 can further establish the device-grouping 304, determine the main controller, or a combination thereof only at specific locations or a specific type of locations. For example, the connection module 822 can establish the device-grouping 304 at locations specified for group interaction, such as a living-room or an entertainment room in a residence or a conference room in a place of business.

The connection module 822 can further establish the device-grouping 304 based on a threshold connection distance. The connection module 822 can have the threshold connection distance, such as 5 feet or 30 feet, for establishing the device-grouping 304. The connection module 822 can connect devices when they are within the threshold connection distance from each other. The connection module 822 can measure the distance between devices from the main controller. The connection module 822 can establish the device-grouping 304 with a device when the device is detected by the main controller and is closer than the threshold connection distance.

The connection module 822 can further establish the device-grouping 304 based on a communication method, a signal strength, or a combination thereof. The connection module 822 can establish the device-grouping 304 using various instances of the communication method, such as NFC, IrDA, WiFi, WiMAX, Bluetooth, or a combination thereof. The connection module 822 can further use cables such as for universal serial bus (USB) or high-definition multimedia interface (HDMI), to enable communication between devices.

The connection module 822 can establish the device-grouping 304 when a signal strength detected by one or more of the devices is greater than a connection power threshold. The connection module 822 can include a threshold level for power reading predetermined by the computing system 100. The connection module 822 can establish the device-grouping 304 with a device when the device is detected by the main controller and the main controller receives a signal from the device exceeding the connection power threshold. The connection power threshold can be specific to the communication method.

The connection module 822 can establish the device-grouping 304 by generating the connection verification 306 of FIG. 3. The connection module 822 can generate an acknowledgement, a verification, a password, a session identifier or a combination thereof for connecting the devices. The connection module 822 can set the connection verification 306 as the acknowledgement, the verification, the password, the session identifier or a combination thereof. The connection module 822 can associate the connection verification 306 with the main controller or any other device connected with the device-grouping 304.

It has been discovered that the device-grouping 304 based on the physical identification signature 210 and the device association 212 and without the direct-input 408 from the individual user 205 provides improved usability. The device-grouping 304 based on the physical identification signature 210 and the device association 212 allows the computing system 100 to identify users based on their natural activities and establish connections between devices without requiring specific instructions or interactions from the user.

It has further been discovered that the device-grouping 304 based on the physical identification signature 210, the device association 212, and the context 308 without the direct-input 408 provides user-specific features without requiring user inputs. The context 308 in conjunction with specific user and device identification allows for the computing system to establish the device-grouping for user specific context using natural activities of the users and without requiring specific instructions or interactions from the user.

The access control module 824 is configured to control access for multiple users across multiple devices in the device-grouping 304. The access control module 824 can be configured to set the access level 214 based on the context 308 for accessing the personal device 102, the group-accommodation device 106, the peripheral device 108, the host device 110, the content 302 or feature thereon, or a combination thereof.

The access control module 824 can use the access level 214 for each instance of the individual-member profile 206 as a baseline and adjust the baseline based on the context 308. For example, the access control module 824 can allow users having content-based access 238 of FIG. 2, such as children, to use more features in the presence of the individual user 205 having the complete-access 232, parental or guardian relationship according to the context 308, or a combination thereof.

Also for example, the access control module 824 can limit accessing or sharing personal or confidential files when the context 308 indicates presence of users outside of specific relationships. As a more specific example, the access control module 824 can allow users with the partial-access 234 to adjust the presentation setting on the group-accommodation device 106, such as channel or brightness, when the context 308 indicates a gathering less than a number of people preset by the computing system 100.

It has been discovered that the access control module 824 using the context 308, the access level 214, and the individual-member profile 206 provide seamless access control in natural activities. The access control module 824 can adjust the access level 214 for individual users through the individual-member profile 206 based on the natural activities indicated by the context 308. The adjustment of the access level 214 using identification information and the context 308 allows providing contextually relevant and user-appropriate features and access without requiring the direct-input 408 from any user.

The access control module 824 can use the first control unit 512, the second control unit 534, the third control unit 634, the host control unit 734, or a combination thereof to control access for various users across multiple devices. The access control module 824 can store the adjustments to the access level 214 or the features or content allowed or limited based on the adjustments in the first storage unit 514, the second storage unit 546, the third storage unit 646, the host storage unit 746, or a combination thereof.

The history module 826 is configured to configured to track usage information. The history module 826 can be configured to determine the access history 216 based on the device-grouping 304, the content history 312, the context 308 or adjustments to any settings or preferences associated therewith, or a combination thereof.

The history module 826 can store the individual-member profile 206 for the individual user 205 or others associated with the device-grouping 304, the context 308 associated with the device-grouping 304, or a combination thereof to determine the access history 216. The information can be stored corresponding to the time and date associated with initiation, duration, termination, modification, or a combination thereof for the device-grouping 304.

The history module 826 can also store information regarding the content 302 along with the individual-member profile 206 for identified users associated with the device-grouping 304, the context 308, or a combination thereof to determine the content history 312. The information can be stored corresponding to the time and date associated with initiation, duration, termination, modification, or a combination thereof for the device-grouping 304 or for the content 302.

The history module 826 can use the first control unit 512, the second control unit 534, the third control unit 634, the host control unit 734, or a combination thereof to organize the information for the access history 216, the content history 312, or a combination thereof. The history module 826 can store the access history 216, the content history 312, or a combination thereof in the first storage unit 514, the second storage unit 546, the third storage unit 646, the host storage unit 746, or a combination thereof.

After enabling access, the control flow can pass to the management module 810. The can pass similarly as described above between the profile module 802 and the identification module 804 using the access history 216, the content history 312, notifications, or a combination thereof. For example, the management module 810 can execute after the connection module 822, the access control module 824, or a combination thereof. Also for example, the management module 810 can execute in parallel and contemporaneously with the access control module 824, the history module 826, or a combination thereof.

The management module 810 is configured to control the content 302, related information and features, or a combination thereof provided to the individual user 205 through the device-grouping 304. The management module 810 can be configured to determine and delegate the personalized material 314 to be simultaneously displayed with the content 302.

The management module 810 can determine the personalized material 314 by searching various providers, such as the provider for the content 302 or the Internet, for material related or associated with the content 302. The management module 810 can search for material specified by the individual user 205 or the recommendation preference 218 determined by the computing system 100 based on the content history 312, profile information, demographic information, user-created content, or a combination thereof. The management module 810 can determine the personalized material 314 by setting the material related to the content 302 as the personalized material 314.

The management module 810 can delegate the personalized material 314 for simultaneously displaying the personalized material 314 and the content 302 across multiple devices. The management module 810 can designate a target location for the content 302, the personalized material 314, or a combination thereof amongst the personal device 102, the group-accommodation device 106, the peripheral device 108, the host device 110, or a combination thereof.

For example, the management module 810 can set the target location for the content 302 as the group-accommodation device 106. The management module 810 can set the target location for the personalized material 314 as the personal device 102, the peripheral device 108, or a combination thereof. As a more specific example, the management module 810 can display and audibly recreate a movie or a show using the television and display or audibly recreate alternate language track, information related to a current scene in the content 302, such as information regarding location or characters in the scene, information regarding actor or actress, or a combination thereof, name of as the sound track, social media comments, or a combination thereof.

Also for example, the management module 810 can set the target location for the content 302, such as a presentation or a document, as the personal device 102. The management module 810 can set the target location for the personalized material 314 such as related search results, related detailed documents, photos, or a combination thereof as the peripheral device 108, the group-accommodation device 106, or a combination thereof.

The management module 810 can also set advertising information as the personalized material 314. The management module 810 can receive advertising information specifically related to the content 302 and the individual user 205. The management module 810 can set the target location for the personalized material 314 to the device not communicating the content 302. For example, the personalized material 314 can be displayed on the personal device 102 or the peripheral device 108 belonging to or nearest to the individual user 205 when the content 302 is displayed on the group-accommodation device 106.

The management module 810 can further delegate the content 302 and the personalized material 314 based on the device-use preference 220. The management module 810 can determine the target location for the content 302, the personalized material 314, or a combination thereof using the delegation preference 242 of FIG. 2. The delegation preference 242 can be determined using inputs from the individual user 205, such as during initialization process or through adjustments during previous viewing or listening session.

The management module 810 can set the settings, such as volume or shortcut keys, for one or more devices in the computing system 100 according to the device setting 240. The device setting 240 can be determined using inputs from the individual user 205, such as initialization data or adjustments made during previous viewing or listening session.

The management module 810 can be configured to specifically receive the content 302 using the personal device 102 from the host device 110. The management module 810 can further transmit the content 302 from the personal device 102 to the group-accommodation device 106 for using the personal device 102 as a receiver and displaying the content 302 on the group-accommodation device 106.

The management module 810 can also be configured to maintain and manage the device-grouping 304. For example, the management module 810 can re-determine the main controller when the previous main controller is removed from the device-grouping 304, such as by powering off or leaving a communication range. Also for example, the management module 810 can prompt the connection module 822 to re-determine the main controller when the previous main controller becomes unresponsive.

The management module 810 can also maintain and manage the device-grouping by removing devices from the device-grouping 304. The management module 810 can remove a device from the device-grouping 304 based on location, distance between devices, signal strength, or a combination thereof. For example, the management module 810 can remove a device from the device-grouping 304 when the device is at a distance greater than a threshold disconnect distance, such as 5 feet or 100 feet, from the main controller as predefined by the computing system 100. The threshold disconnect distance can be the same as or different from the threshold connection distance.

Also for example, the management module 810 can remove the device from the device-grouping 304 when the signals received by the main controller from the device is less than a disconnect power threshold as predefined by the computing system 100. The disconnect power threshold can be the same as or different from the connection power threshold.

It has been discovered that the physical identification signature 210, the device association 212, the device-grouping 304, the recommendation preference 218, and the device-use preference 220 provides personalized accesses in group settings. The computing system 100 can use the physical identification signature 210 and the device association 212 to identify individual users within the group setting. The computing system 100 can use the recommendation preference 218 and the device-use preference 220 to identify the personalized material 314. The computing system 100 can provide the personalized material 314 on the device closest to the individual user 205 or being used by the individual user 205 even in a group setting.

The management module 810 can use the first communication unit 516, the second communication unit 536, the third communication unit 636, the host communication unit 736, the first control unit 512, the second control unit 534, the third control unit 634, the host control unit 734, or a combination thereof to manage the content 302, the personalized material 314, the device-grouping 304, or a combination thereof. The management module 810 can store various interactions or changes with individual users in the first storage unit 514, the second storage unit 546, the third storage unit 646, the host storage unit 746, or a combination thereof.

The interactions or inputs from the individual user 205 during displaying of the content 302, such as volume adjustments or searches for related information, can be passed to the networking module 808. The history module 826 can use the interactions to further determine and adjust the content history 312, the access history 216, or a combination thereof.

The content history 312, the access history 216, or a combination thereof can be passed to the adjustment module 814. The adjustment module 814 is configured to adjust the individual-member profile 206, including the access level 214, the recommendation preference 218, the device-use preference 220, or a combination thereof, based on the access history 216, the content history 312, or a combination thereof.

For example, the adjustment module 814 can have a method for increasing or decreasing the access level 214 for the individual user 205 based on the frequency or duration of the user's device joining the device-grouping, the context 308 related thereto, such as given control by an owner having the complete-access 232 or frequently with only the family members, or a combination thereof.

The command module 812 can execute contemporaneously with the networking module 808, the management module 810, or a combination thereof. The command module 812 can be configured to receive specific commands from the individual user 205. The command module 812 can detect inputs from the individual user 205 including the movement-command 406.

The command module 812 can use one or more camera or microphones across one or more devices in the computing system 100 to determine movements of the individual user 205 having the main controller. The movements of the individual user 205 can be compared to known set of thresholds and descriptions predetermined by the computing system 100 corresponding to specific actions, such as the device-point scenario 410, the device-tap scenario 412, the hand-raise scenario 414, the content-slide scenario 416, the point command scenario 418, the voice command scenario, or a combination thereof. The command module 812 can determine the movement-command when the user's movement matches one or more of the predetermined scenarios.

For example, the individual user 205 can tap the main controller to a new device according to the device-tap scenario 412. The connection module 822 can establish the device-grouping 304 including the new device based on detecting the movement-command from the movement of the individual user 205.

Also for example, the individual user 205 can display the content 302 on the personal device 102 in their hand and move the personal device 102 toward the group-accommodation device 106 or the peripheral device 108 as recognizable by the device-point scenario 410. The command module 812 can further identify the content-slide scenario 416 when the individual user 205 orients the personal device 102 or the peripheral device 108 having the content 302 displayed thereon and “slides” the content toward the other device. The command module 812 can further specify the destination for the content 302 using the point command scenario 418. The management module 810 can transfer the content 302 and display on a corresponding receiving device based on the movement-command 406.

For further example, the command module 812 can recognize a student holding up his or her hand in a classroom setting as the hand-raise scenario 414. The networking module 808 can establish the device-grouping 304 with devices belonging to the student. The management module 810 can further display the content 302 from the student's device to the group-accommodation device 106, such that the student can access the main screen and show their presentation or solve a problem before the rest of the class.

The command module 812 can use the first user interface 518, the second user interface 538, the third user interface 638, the host user interface 738, or a combination thereof to determine the movement-command 406. The command module 812 can use the first control unit 512, the second control unit 534, the third control unit 634, the host control unit 734, or a combination thereof to recognize the movement-command 406 and to prompt the corresponding module and action.

It has been discovered that the context 308, the physical identification signature 210, and the device association 212 along with the movement-command 406 provide simpler and intuitive user interactions in using the computing system 100. The context 308, the physical identification signature 210, and the device association 212 allow for the computing system 100 to specify the user and the context 308 for recognizing movements of the user as the movement-command 406. While the computing system 100 can operate without the direct-input 408 from the user as described above, the movement-command 406 can provide simple and intuitive movements for users to control the computing system 100, such as establishing the device-grouping 304 or transferring the content 302.

The computing system 100 has been described with module functions or order as an example. The computing system 100 can partition the modules differently or order the modules differently. For example, functions of the command module 812 can be combined with the networking module 808 and the management module 810. Also for example, the adjustment module 814 can execute parallel to the command module 812 or independent from the profile module 802.

The modules described in this application can be hardware implementation or hardware accelerators having active circuitry, passive circuitry, or a combination thereof in the first control unit 516 or in the second control unit 538. The modules can also be hardware implementation or hardware accelerators having active circuitry, passive circuitry, or a combination thereof within the personal device 102 or the group-accommodation device 106 but outside of the first control unit 516 or the second control unit 538, respectively.

The physical transformation from the device-grouping 304 using the individual-member profile 206 having the physical identification signature 210 and the device association 212 results in the movement in the physical world, such as the individual user 205 interacting with the content 302 and controlling one or more devices in the computing system 100. Movement in the physical world results in changes to the access history 216 and the content history 312, which can be used to further adjust the individual-member profile 206.

Referring now to FIG. 9, therein is shown a flow chart of a method 900 of operation of a computing system 100 in an embodiment of the present invention. The method 900 includes: detecting a physical identification signature for representing a user in a block 902; detecting a device-identification for representing a device closely associated with the user in a block 904; and establishing a device-grouping based on the physical identification signature and the device-identification for connecting the device with a further device for displaying a content on the device, the further device), or a combination thereof in a block 906.

It has been discovered that the combination of the physical identification signature 210 of FIG. 2 and the device association 212 of FIG. 2 provide improved accuracy in identifying individual users, while the device-grouping 304 of FIG. 3 allows providing personalized information by providing the personalized material 314 of FIG. 3 on a device associated with specific user. The device-grouping 304 based on the physical identification signature 210 and the device association 212 and without the direct-input 408 of FIG. 4 from a user provide improved usability and user-specific features without requiring user inputs or interactions.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a trait-recognition module configured to detect a physical identification signature for representing a user;
a device-recognition module, coupled to the trait-recognition module, configured to detect a device-identification for representing a device closely associated with the user; and
a connection module, coupled to the device-recognition module, configured to establish a device-grouping based on the physical identification signature and the device-identification for connecting the device with a further device for displaying a content on the device, the further device, or a combination thereof.

2. The system as claimed in claim 1 further comprising:
a management module, coupled to the connection module, configured to determine a personalized material for simultaneously displaying the personalized material associated with the content; and
a profile module, coupled to the trait-recognition module, configured to generate a device-use preference for displaying the personalized material, the content, or a combination thereof on the device, the further device, or a combination thereof.

3. The system as claimed in claim 1 further comprising:
a context module, coupled to the device-recognition module, configured to determine a context associated with detecting the physical identification signature and the device-identification; and
wherein:
the connection module is configured to establish the device-grouping based on the context.

4. The system as claimed in claim 1 further comprising:
a context module, coupled to the device-recognition module, configured to determine a context associated with detecting the physical identification signature and the device-identification; and
an access control module, coupled to the connection module, configured to set an access level based on the context for accessing the device, the further device, the content thereon, or a combination thereof.

5. The system as claimed in claim 1 further comprising:
a command module, coupled to the connection module, configured to detect a movement-command; and
wherein:
the connection module is configured to establish the device-grouping based on detecting the movement-command.

6. The system as claimed in claim 1 wherein the connection module is configured to establish the device-grouping without a direct-input.

7. The system as claimed in claim 1 further comprising a management module, coupled to the connection module, configured to delegate a personalized material for simultaneously displaying the personalized material and the content on a combination of the personal device and the group-accommodation device.

8. The system as claimed in claim 1 further comprising:
a history module, coupled to the connection module, configured to determine an access history based on the device-grouping;
an adjustment module, coupled to the history module, configured to adjust an access level based on the access history.

9. The system as claimed in claim 1 further comprising a context module, coupled to the device-recognition module, configured to determine a security breach based on the physical identification signature, the device-identification, or a combination thereof for transmitting the physical identification signature, the device-identification, or a combination thereof.

10. The system as claimed in claim 1 further comprising a management module, coupled to the connection module, configured to receive the content for transmitting the content from a host device directly between the personal device and the group-accommodation device.

11. A method of operation of a computing system comprising:
detecting a physical identification signature for representing a user;
detecting a device-identification for representing a device closely associated with the user; and
establishing a device-grouping with a control unit based on the physical identification signature and the device-identification for connecting the device with a further device for displaying a content on the device, the further device, or a combination thereof.

12. The method as claimed in claim 11 further comprising:
determining a personalized material for simultaneously displaying the personalized material associated with the content; and
generating a device-use preference for displaying the personalized material, the content, or a combination thereof on the device, the further device, or a combination thereof.

13. The method as claimed in claim 11 further comprising:
determining a context associated with detecting the physical identification signature and the device-identification; and
wherein:
establishing the device-grouping includes establishing the device-grouping based on the context.

14. The method as claimed in claim 11 further comprising:
determining a context associated with detecting the physical identification signature and the device-identification; and
wherein:
establishing the device-grouping includes setting an access level based on the context for accessing the device, the further device, the content thereon, or a combination thereof.

15. The method as claimed in claim 11 wherein establishing the device-grouping includes establishing the device-grouping without a direct-input.

16. A non-transitory computer readable medium comprising:
detecting a physical identification signature for representing a user;
detecting a device-identification for representing a device closely associated with the user; and
establishing a device-grouping based on the physical identification signature and the device-identification for connecting the device with a further device for displaying a content on the device, the further device, or a combination thereof.

17. The non-transitory computer readable medium as claimed in claim 16 further comprising:
determining a personalized material for simultaneously displaying the personalized material associated with the content; and
generating a device-use preference for displaying the personalized material, the content, or a combination thereof on the device, the further device, or a combination thereof.

18. The non-transitory computer readable medium as claimed in claim 16 wherein:
determining a context associated with detecting the physical identification signature and the device-identification; and
wherein:
establishing the device-grouping includes establishing the device-grouping based on the context.

19. The non-transitory computer readable medium as claimed in claim 16 further comprising:
determining a context associated with detecting the physical identification signature and the device-identification; and
wherein:
establishing the device-grouping includes setting an access level based on the context for accessing the device, the further device, the content thereon, or a combination thereof.

20. The non-transitory computer readable medium as claimed in claim 16 wherein establishing the device-grouping includes establishing the device-grouping without a direct-input.
